(19) United States
(12) Patent Application Publication
(10) Pub. No.: US 2017/0366238 A1
(43) Pub. Date: Dec. 21, 2017

(54) SYSTEM AND METHOD FOR DISTRIBUTED MIMO COMMUNICATIONS

(71) Applicants: Hou-Shin Chen, San Diego, CA (US); Fu-Hsuan Chiu, San Diego, CA (US)

(72) Inventors: Hou-Shin Chen, San Diego, CA (US); Fu-Hsuan Chiu, San Diego, CA (US)

(21) Appl. No.: 15/625,904

(22) Filed: Jun. 16, 2017

Related U.S. Application Data
(60) Provisional application No. 62/352,531, filed on Jun. 20, 2016.

(51) Int. Cl. H04B 7/0413; H04B 7/155; H04B 7/08

(52) U.S. Cl. CPC H04B 7/0413; H04B 7/0885; H04B 7/155

(57) ABSTRACT

The disclosure provides systems, devices, and methods for distributed relay multiple-in multiple-out (DR-MIMO) communications. The system can have a master transmit node that transmits a message to a master receive node via one or more relay nodes. The relay nodes can each relay a portion of the message, performing a time or frequency shift along with the relay. The multiple relay nodes can function as a distributed antenna array for one or both of the master transmit node and the master receive node, forming a transmit group and/or a receive group. The transmit group and the receive group can thus provide MIMO capabilities to the master transmit node and the master receive node. The master transmit node can transmit multiple spatial streams through distributed relay nodes. The master receive node can receive multiple data streams from distributed relay nodes and perform MIMO detection.

### CROSS REFERENCE TO RELATED APPLICATIONS

This application claims priority to U.S. Provisional Application 62/352,531, filed Jun. 20, 2016, entitled “SYSTEM AND METHOD FOR DISTRIBUTED MIMO COMMUNICATIONS,” the contents of which are hereby incorporated by reference in their entirety.

### BACKGROUND

### Technological Field

This disclosure is generally related to wireless communications. More particularly, the disclosure is related to multiple-input multiple-output (MIMO) communication systems with distributed antennas.

### Related Art

MIMO is an efficient way to boost data rate for wireless communications. This can be especially true in high signal-to-noise ratio (SNR) regions as certain MIMO architectures provide a degree-of-freedom gain allowing additional data streams within point-to-point communications. Multi user MIMO (MU-MIMO), space-division multiple access (SDMA), coordinated multipoint (CoMP), and massive MIMO can all leverage such spatial degrees of freedom to allow high data rate communication between multiple wireless users. As used herein, degrees of freedom in terms of MIMO, may refer to a flexibility of a transmitter to direct antenna beams toward a receiver in downlink. MIMO techniques can also provide diversity gain and power gain under certain conditions.

These benefits can also make MIMO applicable in group-to-group communications. For example, each group can have multiple physically separated and/or disconnected transceiver nodes. Application of certain MIMO architectures using distributed antennas can minimize antenna correlation without limit on the number of antennas in the system.

However, distributed antennas cannot support joint MIMO transmission and joint MIMO detection without additional processing. In addition, whether the channel state information (CSI) is known to the transmit group can play an important role in implementing MIMO techniques.

### SUMMARY

In general, this disclosure describes systems and methods related to distributed MIMO communications systems. The described methods involve signal relay and hence is called distributed relay MIMO (DR-MIMO) communication systems. Variations of DR-MIMO can include distributed frequency-relay MIMO (DFR-MIMO) and distributed time-relay MIMO (DTR-MIMO) both in transmit (Tx) and receive (Rx) modes, and are described in detail below in connection with the figures. The systems, methods and devices of this disclosure each have several innovative aspects, no single one of which is solely responsible for the desirable attributes disclosed herein.

One aspect of the disclosure provides a method for distributed relay multiple-in multiple-out (DR-MIMO) communications in a wireless communication system having a transmit group and a receive group. The method can include transmitting a message having a first spatial stream and a second spatial stream from a master transmit node of the transmit group toward the receive group, the first spatial stream spanning a first band and the second spatial stream spanning a second band. The method can include capturing the second spatial stream at a first relay node of the of the transmit group. The method can include relaying the second spatial stream by the first relay node of the transmit group in the first band as a relayed second spatial stream toward the receive group. The method can include receiving a first data stream comprising the first spatial stream and the second spatial stream and a relayed second data stream comprising the first spatial stream and the second spatial stream at the master receive node. The method can include reconstructing the message at a master receive node based on the first data stream and the relayed second data stream.

Another aspect of the disclosure provides a system for distributed relay multiple-in multiple-out (DR-MIMO) communications in a wireless communication system. The system can have a transmit group. The transmit group can have a master transmit node. The master node can transmit a message having a first spatial stream and a second spatial stream, the first spatial stream spanning a first band and the second spatial stream spanning a second band. The system can have a relay node. The relay node can capture the second spatial stream in the second band. The relay node can relay the second spatial stream in the first band as a relayed second spatial stream. The system can have a receive group. The receive group can have a master receiver node. The master receiver node can receive a first data stream comprising the first spatial stream and the second spatial stream and a relayed second data stream comprising the first spatial stream and the second spatial stream. The master receiver node can reconstruct the message based on the first data stream and the relayed second data stream.

Another aspect of the disclosure provides an apparatus for a non-transitory computer-readable medium in a distributed relay multiple-in multiple-out (DR-MIMO) wireless communication system having a transmit group and a receive group. The medium can have instructions. When executed by a processor, the instructions can cause the system to transmit a message having a first spatial stream and a second spatial stream from a master transmit node of the transmit group toward the receive group, the first spatial stream spanning a first band and the second spatial stream spanning a second band. The instructions can cause the system to capture the second spatial stream at a first relay node of the of the transmit group. The instructions can cause the system to relay the second spatial stream by the first relay node of the transmit group in the first band as a relayed second spatial stream toward the receive group. The instructions can cause the system to receive a second data stream comprising the first spatial stream and the relayed second spatial stream at a first relay node of the receive group in the first band. The instructions can cause the system to transmit the second data stream in the second band as a relayed second data stream toward a master receive node of the receive group. The instructions can cause the system to receive a first data stream comprising the first spatial stream and the second spatial stream and the relayed second data stream comprising the first spatial stream and the second spatial stream at the master receive node. The instructions can cause the system to reconstruct the message at the master receive node based on the first data stream and the relayed second data stream.

Other features and advantages of the present disclosure should be apparent from the following description which illustrates, by way of example, aspects of the disclosure.

### BRIEF DESCRIPTION OF THE FIGURES

The details of embodiments of the present disclosure, both as to their structure and operation, may be gleaned in part by study of the accompanying drawings, in which like reference numerals refer to like parts, and in which:

FIG. 1 is a graphical representation of a distributed relay multiple-in multiple-out (DR-MIMO) communication system;

FIG. 2 is a graphical representation of an embodiment of the transmit group of FIG. 1 using DFR-MIMO;

FIG. 3 is a graphical representation of an embodiment of the receive group of FIG. 1 using DFR-MIMO;

FIG. 4 is a graphical representation of another embodiment of the transmit group of FIG. 1 using DFR-MIMO;

FIG. 5 is a graphical representation of another embodiment of the receive group of FIG. 1 using DFR-MIMO;

FIG. 6 is a graphical representation of another embodiment of the receive group of FIG. 1 using DFR-MIMO;

FIG. 7 is a graphical representation of symmetric frequency relay mode of the system of FIG. 1;

FIG. 8 is a graphical representation of an embodiment of the transmit group of FIG. 1 using DTR-MIMO;

FIG. 9 is a graphical representation of an embodiment of the receive group of FIG. 1 using DTR-MIMO;

FIG. 10 is a graphical representation of an embodiment of Tx DFR-MIMO communications in devices having multiple antennas;

FIG. 11 is a graphical representation of an embodiment of Rx DFR-MIMO communications in devices having multiple antennas;

FIG. 12 is a graphical representation of an embodiment of Tx DTR-MIMO communications in devices having multiple antennas;

FIG. 13 is a graphical representation of an embodiment of Tx DTR-MIMO communications in devices having multiple antennas; and

FIG. 14 is a functional block diagram of a wireless device of the transmit group and the receive group of FIG. 1.

### DETAILED DESCRIPTION

The disclosure may relate to various wireless communication networks such as MIMO, MU-MIMO, massive MIMO, and SDMA, as noted above. This disclosure can also relate to Code Division Multiple Access (CDMA) networks, Time Division Duplex (TDD) networks, Time Division Multiple Access (TDMA) networks, Frequency Division Duplex (FDD) networks, Frequency Division Multiple Access (FDMA) networks, Orthogonal FDMA (OFDMA) networks, Single-Carrier FDMA (SC-FDMA) networks, etc. The terms “networks” and “systems” or “communication systems” are often used interchangeably. However, the applicability of the disclosed methods and systems to other communication systems and other signal transmission/reception technology will be appreciated by one of skill in the art.

This disclosure presents systems and methods which can enable both joint MIMO transmission of data and joint MIMO detection which can provide the full benefits of MIMO techniques by distributed antennas. This technique is referred to herein as Distributed Relay MIMO (DR-MIMO). With the DR-MIMO, distributed antennas can be used as if they were collocated antennas. The existing point-to-point MIMO techniques with collocated antennas can be directly implemented within group-to-group communications without alteration. For a communication system having n-number (n being an integer) of nodes in both transmit and receive groups, DR-MIMO can provide theoretical n3 power gain or range improvement. As used herein, a “communication node,” or “node” (e.g., relay node or master node) can be any wireless communication device, such as a user equipment (UE), user terminal, an access point (AP), a base station (BS), or other similar stationary or mobile wireless electronic device.

DR-MIMO can provide all of the benefits of MIMO with collocated antennas and has no limit on the number of antennas because there is no limitation by antenna correlation within collocated antennas. Furthermore, DR-MIMO provides a plug-and-play improvement for all existing wireless communications standards. Distributed transmit beamforming or distributed MU-MIMO may increase communication capacity particularly in a local area network (LAN). Distributed transmit beamforming can rely on capabilities of forming multiple beams by a large number of transmit antennas to serve multiple user devices or user terminals. In some cases, this can be described as a simplified use case of group-to-group MIMO communications in which the receive terminals perform no joint MIMO detection. In such an example, interference management is handled at the transmit side by precoding with respect to a known MIMO channel matrix. In order to realize joint MIMO transmission, all transmit nodes need to achieve a tight synchronization in both time and frequency and share transmit information.

Group time-frequency synchronization can be achieved by a master-slave architecture in which a master node transmits a reference signal to all other slave nodes. A master node in this sense is a communication device that transmits a message or data to a destination device (e.g., a receive node or receive group). However, sharing transmit information to the other separated nodes can be difficult. In some examples, the application of distributed beamforming in a wireless LAN (WLAN) architecture can be restricted to multiple centralized APs having backhaul connections to avoid wireless transmit information sharing.

Relay nodes associated with the master node can relay the signals broadcasted by the master node to avoid the need to share transmit information. This can be random beamforming having no beamforming weightings that can be performed at any relay antenna. Thus this may result in moderate transmit diversity gain. As for the acquisition of the channel state information in the transmit side, time division duplex (TDD) is widely considered to explore the channel reciprocity between the downlink and uplink channels. But, collecting the channel states in distributed antenna represents another challenging task.

MIMO detection at the receive side of the communication channel can be difficult to accomplish because of the difficulty of collecting signals from distributed antennas. However, without joint MIMO detection, both receive diversity gain and degree-of-freedom gain cannot be obtained.

The detailed description set forth below, in connection with the accompanying drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in simplified form for brevity of description.

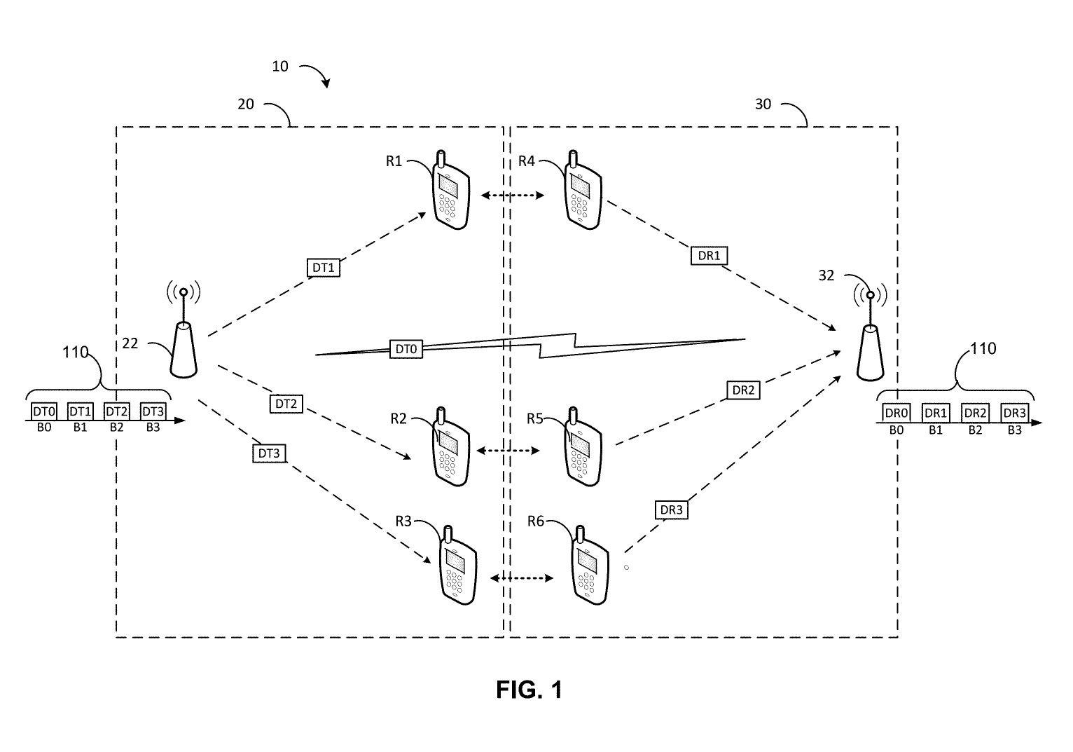

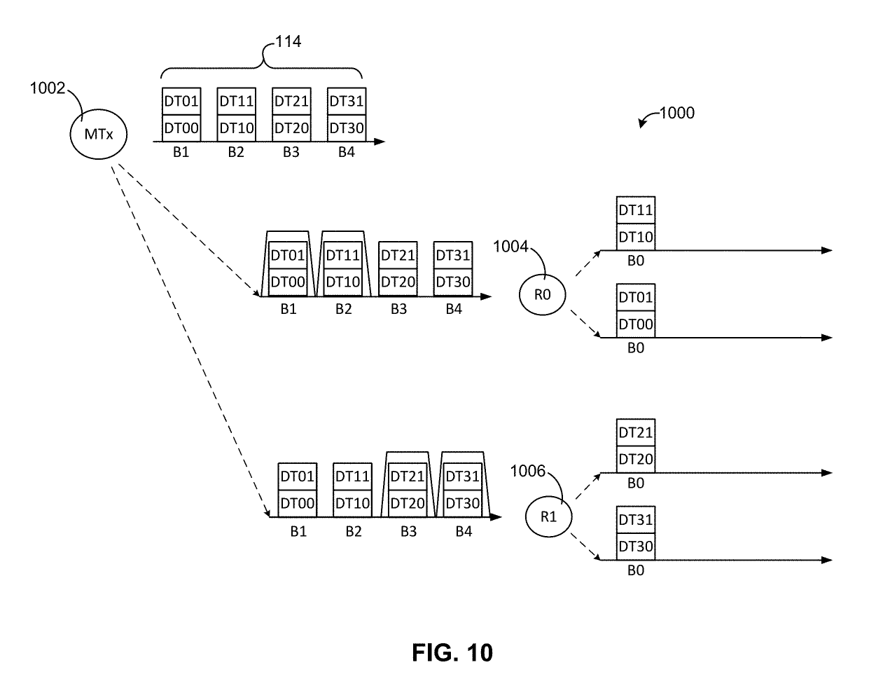

FIG. 1 is a graphical representation of a distributed relay MIMO communication system. A communication system 10 can have a transmit group 20 and a receive group 30. The transmit group 20 can have at least one transmitter 22 and one or more relay nodes R1, R2, R3. Similarly, the receive group 30 can have at least one receiver 32 and one or more relay nodes or relay device R4, R5, R6. While a single transmitter 22 and a single receiver 32 are used as a primary example throughout the following description, more than one transmitter 22 and more than one receiver 32 may be present in the system 10 through FDMA, TDMA or CDMA methods. The transmitter 22 and the receiver 32 are depicted as a tower or access point and the relay nodes as mobile phones, however this should not be considered limiting. The disclosed methods described in connection with the following figures can be implemented in any wireless communication device (see FIG. 10). Additionally, as used herein, a node (e.g., relay node or master node) can be any wireless enabled communications device.

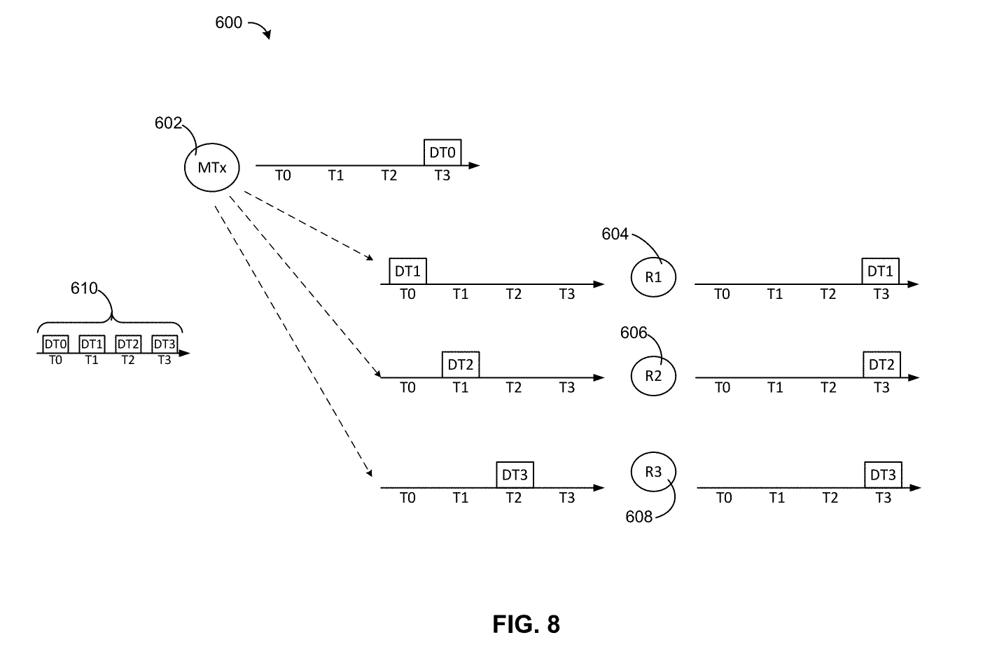

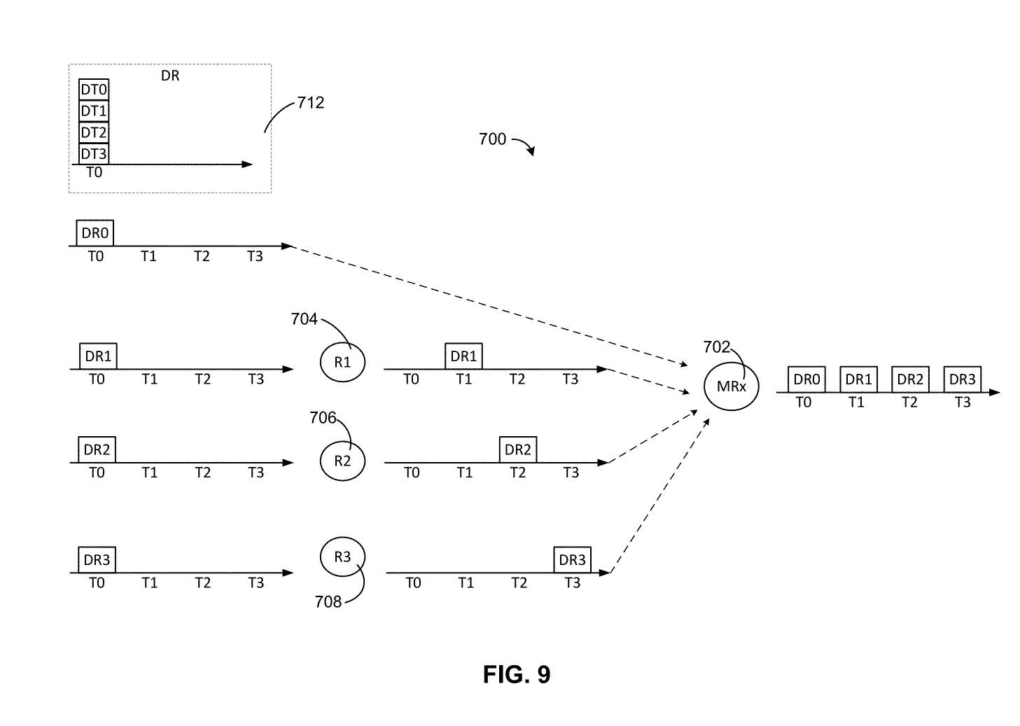

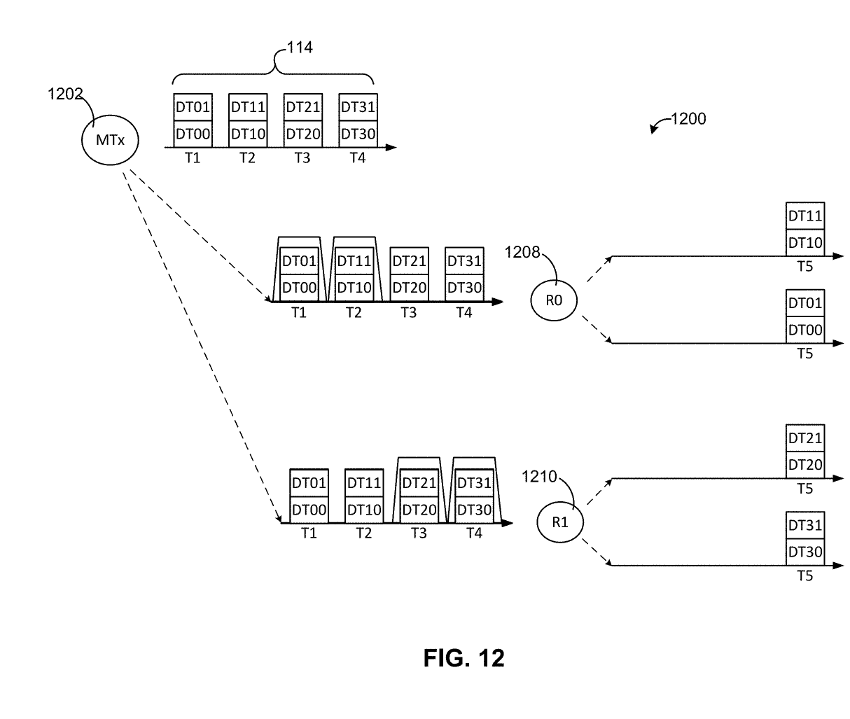

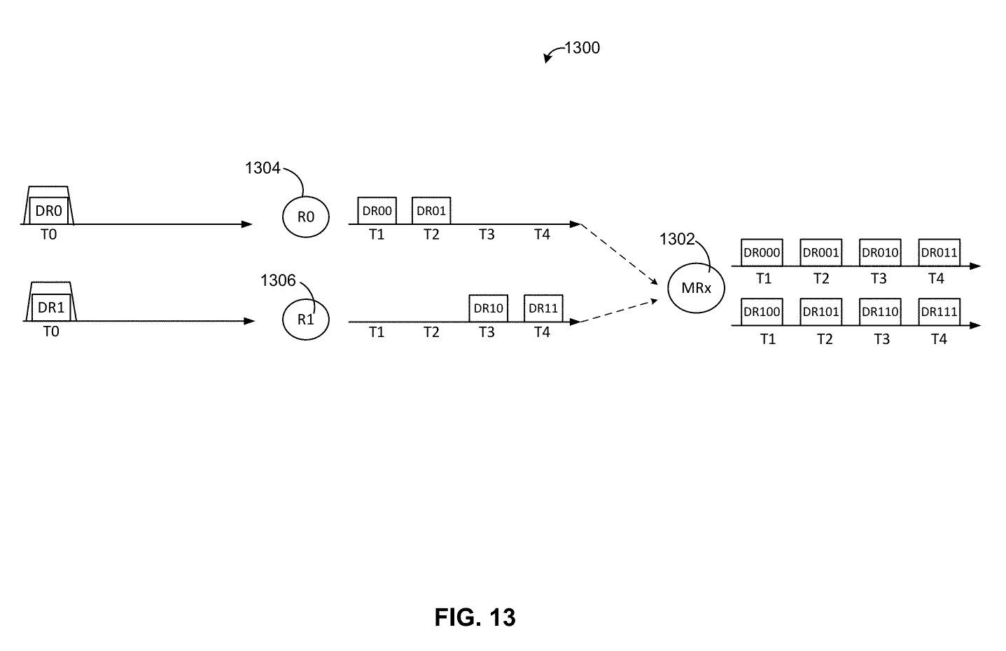

The transmitter can transmit a message as a signal 110 intended for reception at the receiver 32. As described herein, the transmitter 22 can split transmissions such as the signal 110 in frequency in order to distribute the communications and implement distributed MIMO. In the example shown, the signal 110 can have four spatial streams DT0, DT1, DT2, DT3 (e.g., using FDMA) in four different bands B0, B1, B2, B3. The four different bands B0, B1, B2, B3 can be non-overlapping, contiguous or noncontiguous frequency bands, for example. The relay nodes R1, R2, R3 can then perform a simple relay (e.g., analog relay) operation and forward a received portion (e.g., DT1, DT2, DT3) of the received signal from the transmitter 22 toward the receive group 30 and the receiver 32. Portions of the signal 110 can also go directly from the transmitter 22 to the receiver 32, as shown (e.g., DT0). The receiver 32 can receive the data DR0 in B0 and the other three relayed data streams (e.g., DR1, DR2, DR3) in 3 different bands B1, B2 B3. The receiver 32 can then perform MIMO detection and receive the complete signal 110. The bands B0, B1, B2, B3 are described here in connection with frequency bands. However, the term “bands,” as used herein, can also more generally refer to a duration of time or a time slot (e.g., T0, T1, T2, T3, etc.), as described below in connection with FIG. 8, FIG. 9, FIG. 12, and FIG. 13, for example.

The relay nodes R1, R2, R3 can relay portions DT1, DT2, DT3 of the signal 110 toward the receive group 30. The relay nodes R4, R5, R6, as part of the receive group 30 can relay its received data to the receiver 32. The transmit group 20 may operate with a receive group 30 as shown in FIG. 1 or a single receive device with multiple antennas. Similarly, the receive group 30 may operate with the transmit group 20 or a single transmit device with multiple antennas. Thus, in some embodiments, the relay nodes R1, R2, R3 can be the same devices as the relay nodes R4, R5, R6. Thus the relay nodes 1, 4 can be the same device, the relay nodes 2, 5 can be the same device, and the relay nodes 3, 6 can be the same device, for example.

The system does not require any higher level interaction to accomplish the distributed MIMO. The relay instructions can be provisioned in each device or otherwise predefined based on the environment. The master node can define the relay instructions for the relay nodes and the definitions can be made on the fly.

### DR-MIMO by FDMA

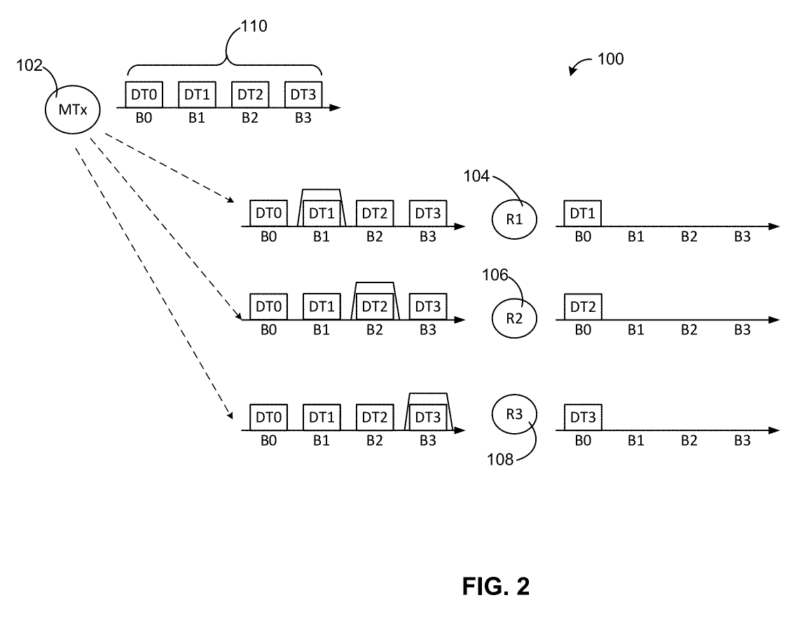

FIG. 2 is a graphical representation of an embodiment of the transmit group of FIG. 1 using DFR-MIMO. A transmit group 100 of the communication system (system) 10 can have multiple communication nodes. The transmit group 100 can be similar to the transmit group 20 (FIG. 1). The transmit group 100 is an example of DR-MIMO using frequency division multiple access (FDMA), or Distributed-Frequency-Relay MIMO (DFR-MIMO). The transmit group 100 can use a DFR-MIMO scheme to realize transmission of multiple spatial streams with multiple distributed antennas. In some embodiments, the transmit group 100 can have four exemplary communication nodes: a master node 102 and three relay nodes R1 104, R2 106, R3 108. The master node 102 is indicated “MTx” (master transmit node). Each relay node R1 104, R2 106, R3 108 may have a single antenna. It should be appreciated, however, that DR-MIMO is not limited to relay nodes with a single antenna. DR-MIMO can conveniently implement distributed antennas, located in different places in a joint or coherent manner to transmit multiple spatial streams. In the illustrated example, one or more of the master node 102 and relay nodes R1 104, R2 106, R3 108 can have multiple antennas.

The transmit group 100 can perform, for example, transmission of four spatial streams using the four antennas located in the distributed nodes (e.g., the master node 102 and the three relay nodes R1 104, R2 106, R3 108). In some embodiments, the transmit group 100 can have more than three relay nodes 104, 106, 108 as needed.

The master node 102 can generate the four spatial streams DT0, DT1, DT2, DT3 that form the signal 110. The spatial streams of the signal 110 are labeled DT0, DT1, DT2, DT3 for example. The master node 102 can transmit the spatial streams DT0, DT1, DT2, DT3 in a main band B0 and three different relay bands B1, B2, B3. The main band is the band used to communicate with the end terminal (e.g., the receiver 32). The main band B0 and the relay bands B1, B2, B3 can be contiguous or noncontiguous frequency bands, for example. Each frequency band B0, B1, B2, B3 can contain one of the spatial streams DT0, DT1, DT2, DT3. Each of the frequency bands can be a different, non-overlapping frequency band. Each of the relay nodes 104, 106, 108 can receive (or capture) the spatial streams in one or more of the three relay bands B1, B2, B3 and repeat, or relay, the respective spatial stream in the main band B0.

The “main band” (e.g., B0) as used herein can refer to the bandwidth designated for a specific type of communication. For example, the main band can be a specified bandwidth in which, for example, a wireless service provider has contracted to provide wireless services. The relay bands, on the other hand, can be different or higher frequency bands (e.g., super high frequency, 3 GHz to 30 GHz) that may have shorter range or are not specifically designated for long range use on the same wireless protocol.

As shown, the relay node 104 can receive or capture the spatial stream DT1 in the relay band B1, indicated with a trapezoid around DT1. The relay node 106 can receive the spatial stream DT2 in the relay band B2, indicated with the trapezoid around DT2. The relay node 108 can receive the spatial stream DT3 in the relay band B3, indicated with the trapezoid around D3. As used herein, a trapezoid indicates the spatial stream received, captured, or selected by the relay nodes 104, 106, 108 for relay. The entire signal 110 may be transmitted to each of the relay nodes 104, 106, 108, but only the spatial stream noted by the trapezoid is relayed to the receiver side.

Each of the relay nodes 104, 106, 108 can relay the respective received spatial streams DT1, DT2, DT3 in the main band B0 to the receive group 30 of the communication system 10. In some embodiments, the spatial stream DT0 can be transmitted by the master node 102 in the main band B0 directly to the receiver side 30 of the communication system 10 without relay. As used herein the receive group 30 can be a single destination device such as the receiver 32 or multiple devices.

In this way, the four spatial streams DT0, DT1, DT2, DT3 can be transmitted in the main band B0 by four different antennas: one antenna from the master node 102, and the three other (distributed) antennas from the relay nodes 104, 106, 108. Each spatial stream DT0, DT1, DT2, DT3 can encounter distinct channel fading because the four nodes of the transmit group 100 are randomly distributed and far away from each other in terms of wavelength.

In some embodiments, any required physical layer (PHY) or upper layer operations are performed at the master node 102 alleviating the need for any processing at the relay nodes 104, 106, 108. Isolating the PHY and upper layer processing to the master node 102 can save processing power for a communications system. The relay nodes 104, 106, 108 can simply perform analog signal relay. The analog relay can further be used to extend signal coverage or communication range.

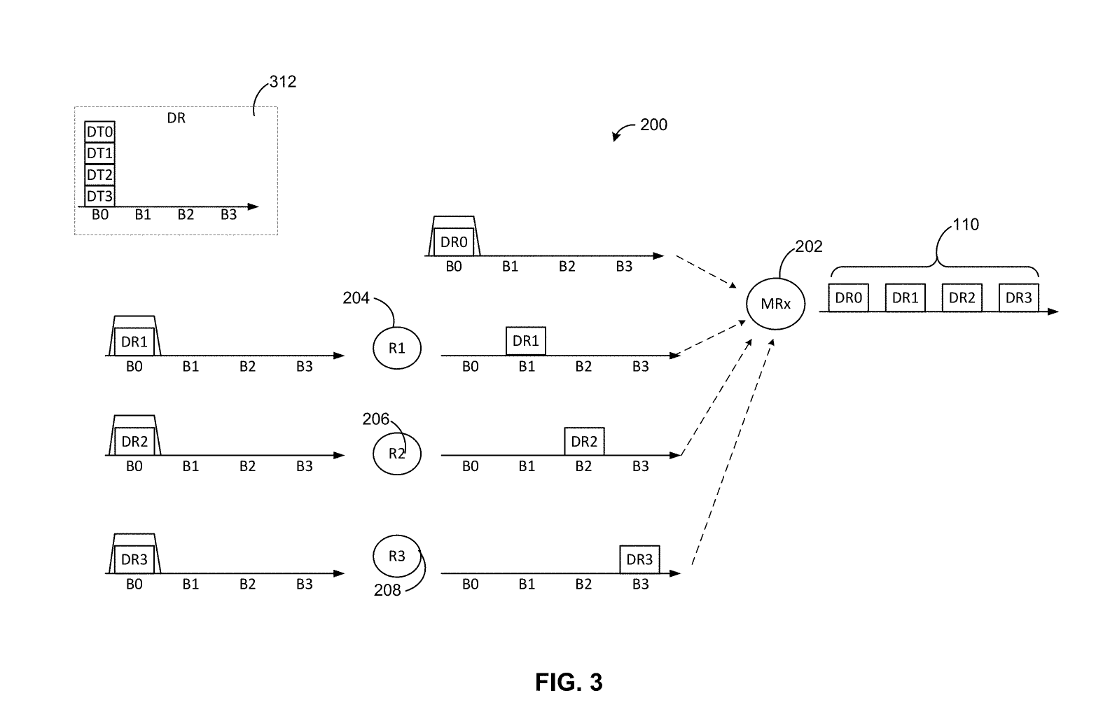

FIG. 3 is a graphical representation of an embodiment of the receive group of FIG. 1 using DFR-MIMO. A receive group 200 can be similar to the receive group 30 (FIG. 1) and have a similar configuration to the transmit group 100 of FIG. 2. The receive group 200 can have one master node 202 (e.g., the receiver 32) and three relay nodes 204, 206, 208, each having at least one antenna, similar to the relay nodes 104, 106, 108. The master node 202 is indicated “MRx” (master receive node).

In the receive group 200, each of the relay nodes 204, 206, 208 can receive or capture incoming signals in the main band B0. In some examples, the main band B0 can be the frequency band used to receive signals from the transmit side 100. Since each of the spatial streams DT0, DT1, DT2, DT3 transmitted from the transmit side 20 are transmitted in the same band B0, then the relay nodes 204, 206, 208 receive mixtures of all four spatial streams DT0, DT1, DT2, DT3 as a received signal 312. The received signal 312 is labeled “DR” and can be considered a data stream. Each of the relay nodes 204, 206, 208 can then relay or repeat a version of the received signal 312 (e.g., data streams DR0, DR1, DR2, DR3) on, or shifted into, three relay bands B1, B2, B3 to the receiving master node 202. In some embodiments, the data streams of FIG. 3 can be a combination of all spatial streams that were transmitted/relayed from the transmit group 100. Note that the transmit DR-MIMO or receive DR-MIMO can be used independently. When the transmit DR-MIMO is used the receive side (e.g., the receive group 30) can either use collocated antennas or distributed antennas. Similarly, when receive DR-MIMO is used the transmit side (e.g., the transmit group 20) can either use collocated antennas or distributed antennas.

The master node 202 can then receive four uncorrelated or different copies of the signal 312 (DR0, DR1, DR2, DR3) in the main band B0 and three relay bands B1, B2, B3. The master node 202 can then perform joint MIMO detection to recover the message within the signal 110. Joint MIMO detection means that different copies DR1, DR2, DR3 of the signal 312 (e.g., contents of the transmit signal 110 that experience different channel fading on different wireless channels) are processed together to receive the message of the signal 110.

In examples such as the one shown in FIG. 3, a 4×4 MIMO arrangement can be used to describe the reception of four data streams using DFR-MIMO, similar to above. However, it should be appreciated that DFR-MIMO can be applied to any size MIMO configuration or communication system, provided that there are sufficient numbers of relay nodes and relay bands available for use. For example, DFR-MIMO could be used in conjunction with 10×10 MIMO or other multi-antenna configuration as desired.

In some embodiments, the frequency bands used for DFR-MIMO can be contiguous or noncontiguous.

In some embodiments, the Tx DFR-MIMO (FIG. 2) and Rx DFR-MIMO (FIG. 3) can operate independently. For example, collocated transmit antennas on a single device can be used with a Rx DFR-MIMO enabled group. In some other embodiments, a Tx DFR-MIMO enabled group can be used with collocated receive antennas on a single device.

In some embodiments, the transmit group 100 can use Tx DFR-MIMO and perform space-time coding to obtain transmit diversity gain.

In some embodiments, the receive group 200 can use Rx DFR-MIMO to obtain receive diversity gain and power gain.

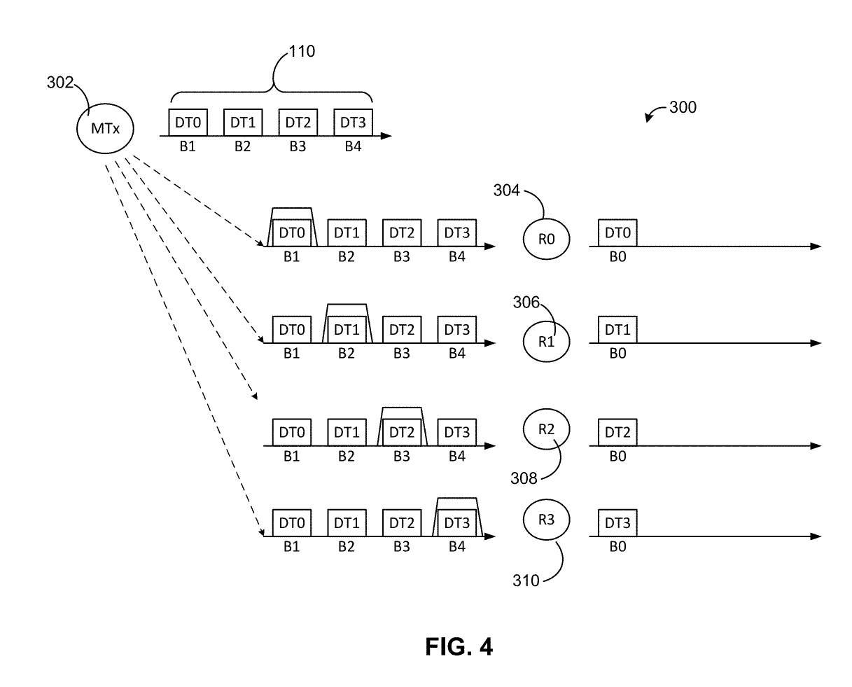

FIG. 4 is a graphical representation of another embodiment of the transmit group of FIG. 1 using DFR-MIMO. A transmit group 300 can have a master node 302 and four relay nodes 304, 306, 308, 310. The master node 302 (e.g., the transmitter 22) can transmit signals (the spatial streams DT0, DT1, DT2, DT3) in relay bands B1, B2, B3, B4 similar to above. The four relay nodes 304, 306, 308, 310 relay four spatial streams DT0, DT1, DT2, DT3, to the main band B0.

For example, the master node 302 can transmit the signal 110 in four bands, B1, B2, B3, and B4. The relay node R0 304 can receive the spatial stream DT0 in the relay band B1 and transmit in a main band B0. The relay node R1 306 can receive a portion of the signal 110 (spatial stream DT1) in relay band B2 and transmit in main band B0. The relay node R2 308 can receive a portion of the signal (spatial stream DT2) in relay band B3 and transmit in main band B0. The relay node R3 310 can receive a portion of the signal 110 (spatial stream DT3) in relay band B4 and transmit in main band B0. Thus, each of portions of the signal 110 (spatial streams DT0, DT1, DT2, DT3) can be transmitted in the main band B0 to the receive group 30, for example.

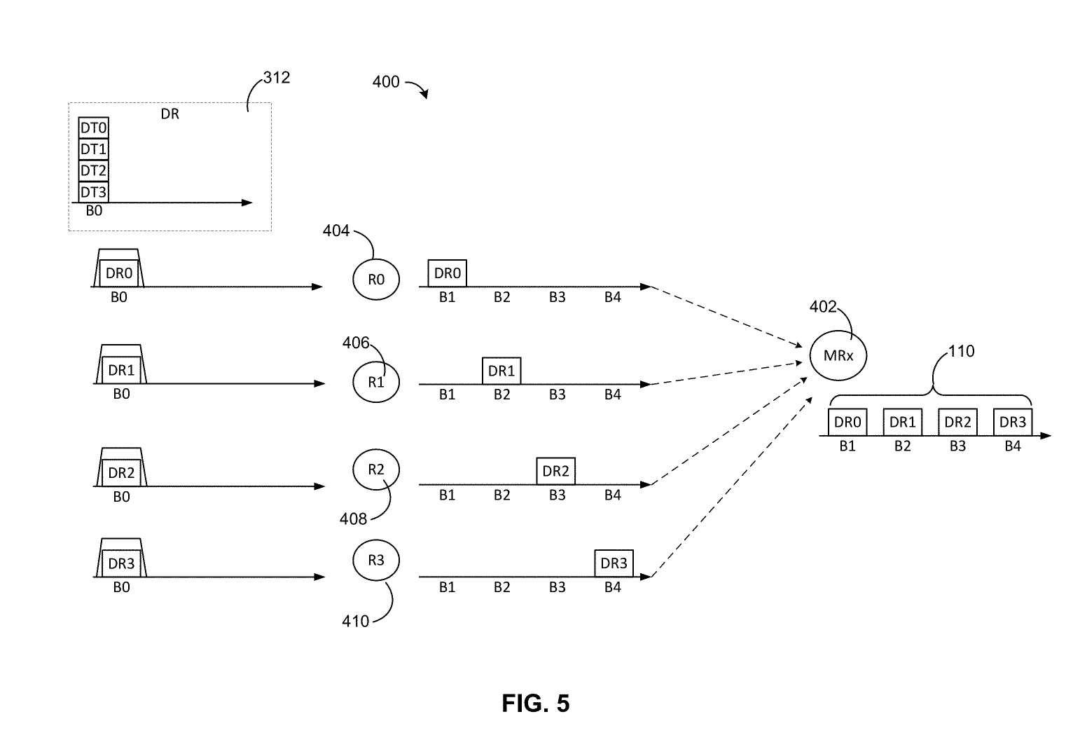

FIG. 5 is a graphical representation of another embodiment of the receive group of FIG. 1 using DFR-MIMO. A receive group 400 can have a master node 402 and four relay nodes R1 404, R2 406, R3 408, R4 410. The four relays nodes R1 404, R2 406, R3 408, R4 410 relay a version of the received signal 312 received in the main band B0 into four relay bands B1, B2, B3, B4. For example the data streams DR0, DR1, DR2, DR3 can each be a mixture or combination of the four data streams DT0, DT1, DT2, DT3 received in the main band B0, but subjected to different environmental factors (e.g., channel fading) during transmission. The master node 402 can receive signals (the data streams DR0, DR1, DR2, DR3) from the four relay bands and perform joint MIMO detection.

Although one more relay node and one more relay band are present in the embodiments of FIG. 4 and FIG. 5, the RF circuit design of the transmitting unit can be simplified. For example, with the transmit group 300, the master node 302 need not address power control given the different power allocations for the communicating band B0 and the relay bands B1, B2, B3 in FIG. 2. As another example, in FIG. 2 if the communicating band B0 and the relay bands B1, B2, B3 are closed to each other, the leakage from high power communicating band may cause interference to the relay bands.

The transmit group 100 or 300 can use Time Division Duplex (TDD) for transmission and reception while implementing DFR-MIMO. However, DFR-MIMO is not limited only to TDD.

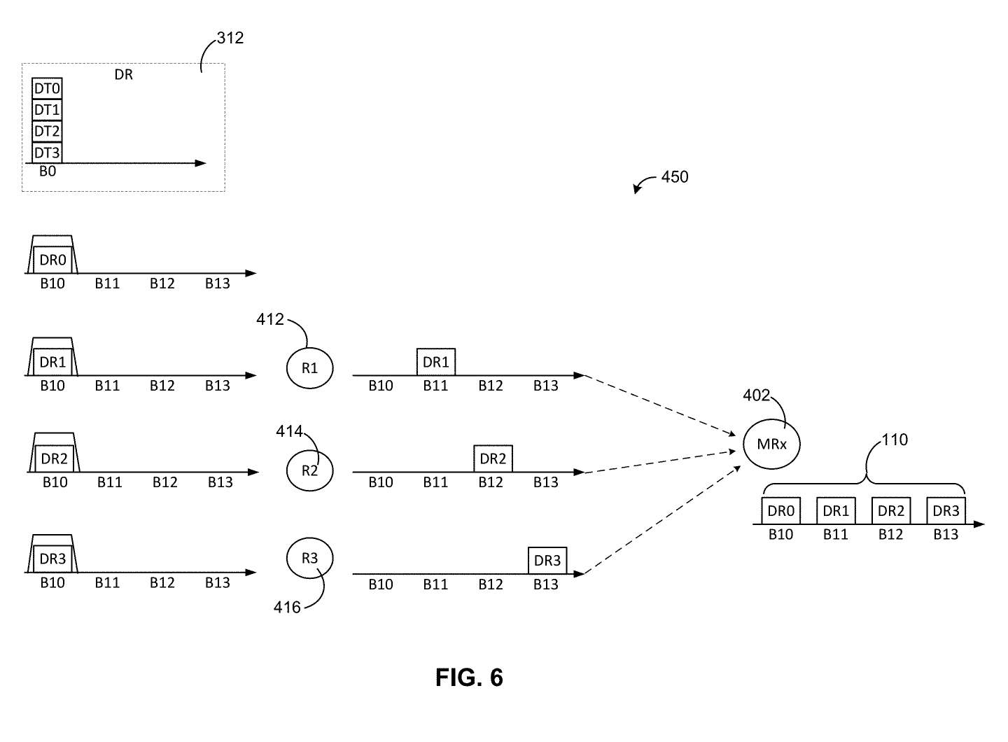

FIG. 6 is a graphical representation of another embodiment of the receive group of FIG. 1 using DFR-MIMO. The DFR-MIMO scheme of the transmit group 100 or 300 can also be coupled with Frequency Division Duplex (FDD), though additional bandwidth or bands may be needed to perform DFR-MIMO in FDD systems. For example, the transmit group 100 can use the Tx DFR-MIMO of FIG. 2 for transmission and can use Rx DFR-MIMO of FIG. 3 for reception but B0, B1, B2 and B3 are replaced with four different bands B10, B11, B12 and B13 as shown in FIG. 6. In FIG. 6, the master node 402 can receive signals in all four bands B10, B11, B12, B13. The master node 402 can receive the data stream DR0 in the band B10. A relay node 412 can receive the data stream DR1 in band B10 and transmit the data stream DR1 to the master node 402 in band B11. A relay node 414 can receive the data stream DR2 in the band B10 and transmit it to the master node 402 in the band B12. A relay node 416 can receive the data stream DR3 in the band B10 and transmit it to the master node 402 in B13. Accordingly, the master node 402 receives four copies of data streams and can perform joint MIMO detection.

The number of nodes in a transmit group (e.g., the transmit group 20) or receive group (e.g., the receive group 30) can be large. In some embodiments, the transmit groups or the receive groups can have ten or more nodes that can each be master nodes or relay nodes as needed. In such a case, the relay nodes can be divided into four subgroups and nodes in the same subgroup follow the same relay manner, for example, the same band for DFR-MIMO and the same band, or “time slot” for DTR-MIMO. “Time slot” is used herein primarily to describe a period of time (e.g., T0, T1, T2, T3), however, the term band can also be used in a more general sense. Although, the degree of freedom gain may be reduced, receiver complexity is reduced (e.g., from 10×10 to 4×4) and diversity gain and power gain are increased, since the relay nodes can enhance the signal power and transmit the signals (e.g., the data streams DT0, DT1, DT2, DT3) through different paths.

In some examples, any capable node can become the master node (e.g., the master node 302) for transmission by Time-Division Multiple Access (TDMA) resource sharing.

In some embodiments, simultaneous transmission of multiple master nodes (e.g., the master node 102, 302) can be achieved using FDMA or Orthogonal Frequency Division Multiplexing Access (OFDMA).

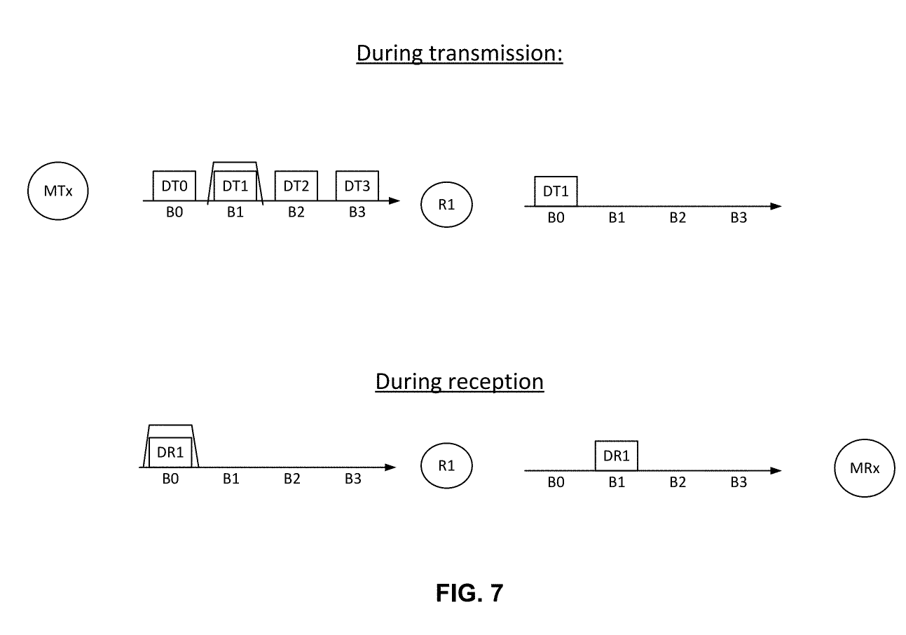

FIG. 7 is a graphical representation of symmetric frequency relay mode of the system of FIG. 1. When the group is under transmission (e.g., the transmit group 20, 100, 300), the relay node R1 can relay the spatial stream DT1, receiving in band B1 and relaying DT1 in the main band B0. When the group is under reception (e.g., the receive group 30, 200, 400), the relay node R1 can relay the signal DR1, receiving the signal DR1 in B0 and relaying it to the master node in B1. If all relay nodes in the transmit group 20 and the receive group 30 follow symmetric frequency relay, the physical channel between two master nodes (e.g., the master nodes 102, 202 or the master nodes 302, 402) are reciprocal, for example, the downlink channel and the uplink channel are approximately the same. Thus, when the DFR-MIMO with symmetric frequency relay is coupled with TDD, the master node can obtain the complete MIMO channel matrix by exploiting channel reciprocity. Accordingly, MU-MIMO can be easily implemented by Tx DFR-MIMO since the master transmit node would be able to have the MIMO channel matrix by channel reciprocity.

### DR-MIMO by TDMA

FIG. 8 is a graphical representation of an embodiment of the transmit group of FIG. 1 using DTR-MIMO. A transmit group 600 (similar to the transmit group 20) can have of four nodes: a master node 602 and three relay nodes 604, 606, 608 where each relay node has one antenna.

The master node 602 can generate four spatial streams for four transmit antennas. The master node 602 can transmit three spatial streams DT1, DT2, DT3 to three relay nodes 604, 606, 608 at time slot T0, T1, and T2 (respectively). Each of the three relay nodes 604, 606, 608 can receive (capture) the spatial streams from master node 602 and buffer the data in the respective time slot.

The master node 602 and three relay nodes can then transmit the four spatial streams at time slot T3. Accordingly, the four spatial streams DT1, DT2, DT3, DT4 are transmitted by four different antennas to a receive group (e.g., the receive group 30) in the same time slot T3.

FIG. 9 is a graphical representation of an embodiment of the receive group of FIG. 1 using DTR-MIMO. A receive group 700 (similar to the receive group 30) can have four nodes: a master node 702 and three relay nodes 704, 706, 708 where each node can have one or more antennas similar to above.

In some embodiments, the master node 702 and the three relay nodes 704, 706, 708 can receive signals in a time slot T0. The data streams arrive at the relay nodes 704, 706, 708 as a received signal 712 (labeled DR, similar to above), for example. The three relay nodes 704, 706, 708 can buffer a respective version of the received signal 712 (e.g., DR01, DR1, DR2, DR3) in the time slot T0 and transmit their respective data to the master node 702 at the time slots T1, T2, and T3 as shown. The DR0 data stream can be received directly from, for example, the master node 602 (e.g., the transmitter 22) in the transmit group 600 without relay, for example.

The master node 702 can then buffer the four signal or data streams DR0, DR1, DR2, DR3 and perform joint MIMO detection to recover the original contents of the message sent in the signal 610 (FIG. 8).

For the DTR-MIMO, note that a 4×4 MIMO can be used to describe the concept of the DTR-MIMO. The DTR-MIMO can be applied to any size of MIMO architecture provided that there are enough relay nodes for each data stream and sufficient buffer capability at each node. The Tx DTR-MIMO (FIG. 8) and Rx DTR-MIMO (FIG. 9) can be implemented independently, in for example, collocated transmit antennas on a device with a Rx DTR-MIMO enabled group, or a Tx DTR-MIMO enabled group with collocated receive antennas on a device (e.g., the receiver 32). In some examples Tx DTR-MIMO can be used to perform space time coding and obtain transmit diversity gain. Further, Rx DTR-MIMO can be used to obtain receive diversity gain. In addition, it should be appreciated that the DTR-MIMO is not limited to nodes with single antenna for transmit/receive operations.

The examples of FIG. 8 and FIG. 9 assume TDD for transmission and reception. However, DTR-MIMO is not limited to TDD. The DTR-MIMO scheme can be coupled with FDD with separate transmit band and receive band.

The number of nodes in a group can be large e.g., ten nodes but instead of performing a 10×10 MIMO, a 4×4 MIMO may be preferable in some instances. In this case, the nodes into can be divided into four subgroups and nodes in the same subgroup follow the same relay manner.

In some embodiments, all of the nodes in a given communication system (e.g., the system 10), whether designated as a “master node” or a “relay node” can assert a need to operate as the master node for transmission by Time Division Multiple Access (TDMA) resource sharing.

A group configured as DTR-MIMO can communicate with another group configured as DFR-MIMO, for example, a Tx DTR-MIMO group can communicate with an Rx DFR-MIMO group, and a Tx DFR-MIMO can communicate with an Rx DTR-MIMO group.

### Collocated Antennas with DR-MIMO

In some embodiments, the DR-MIMO communications methods and systems described herein can be coupled with nodes having multiple antennas to increase degree-of-freedom gain.

### Tx DFR-MIMO

FIG. 10 is a graphical representation of an embodiment of Tx DFR-MIMO communications in devices having multiple antennas. A transmit group 1000 can have three nodes where a master node 1002 has two antennas and two relay nodes 1004, 1006 each have two antennas. As shown in FIG. 10 The master node 1002 can generate a signal 114 having eight data streams, DT00, DT10, DT20, DT30, DT01, DT11, DT21, DT31. The four data streams, DT00, DT10, DT20 and DT30 are transmitted by its first antenna in four relay bands, B1, B2, B3 and B4. The other four data streams, DT01, DT11, DT21 and DT31 are transmitted by its second antenna in four relay bands, B1, B2, B3 and B4. The relay node R0 1004 can capture data streams in two relay bands, B1, B2. The relay node R0 can use its first antenna to relay data stream from B1 to main communication band B0 and use its second antenna to relay data stream from B2 to main communication band B0. Similarly, the relay node R1 1006 can capture data streams in two relay bands, B3, B4. The relay node R1 1006 can use its first antenna to relay data stream from B3 to main communication band B0 and use its second antenna to relay data stream from B4 to main communication band B0. In this example, the maximum degree-of-freedom gain is 2×2×2=8 while the total number of antennas is 2+2×2=6.

### Rx DFR-MIMO:

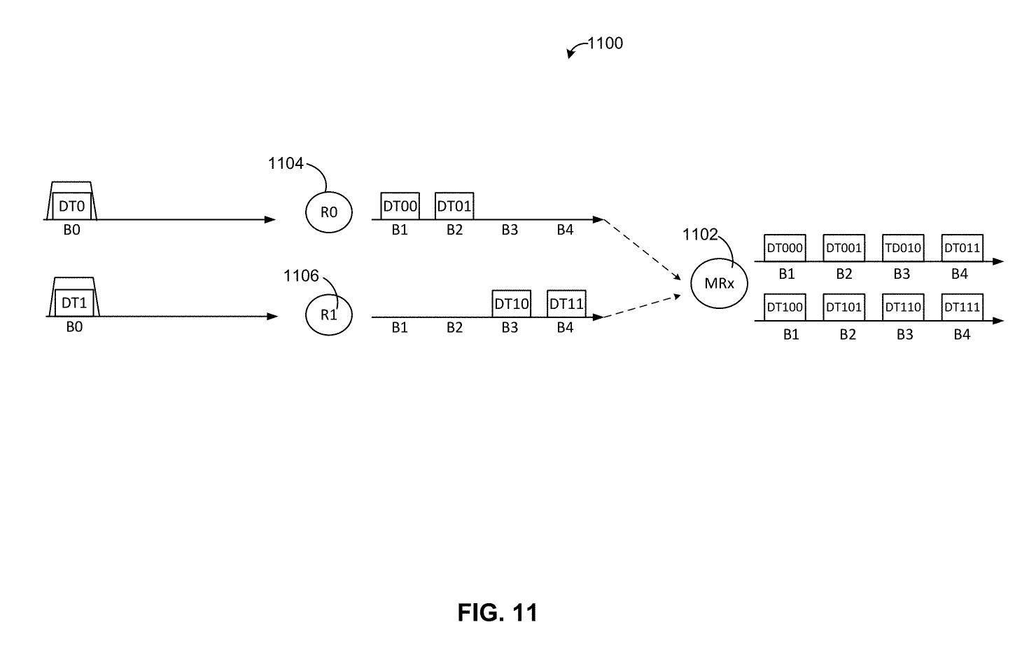

FIG. 11 is a graphical representation of an embodiment of Rx DFR-MIMO communications in devices having multiple antennas. A receive group 1100 has one master node 1102 and two relay nodes R0 1104, R1 1106. Each node has two antennas. The relay node R0 1104 captures the data stream DT0 in B0 and uses its two antennas to relay the signal to two relay bands, B1 and B2. Similarly, the relay node R1 1106 captures the data stream DT1 in B0 and uses its two antennas to relay the signal to two relay bands, B3 and B4. The master node 1102 can receive four copies of the signal from its first antenna in four relay bands and four copies of the signal from its second antenna in four relay bands. Thus, the master node 1102 receives eight copies of the signal in total. The maximum degree-of-freedom gain is 2×2×2=8 while the total number of antennas is 2+2×2=6.

### Tx DTR-MIMO:

FIG. 12 is a graphical representation of an embodiment of Tx DTR-MIMO communications in devices having multiple antennas. In another example, a transmit group 1200 can have three nodes where a master node 1202 has two antennas and two relay nodes 1208, 1210 each have two antennas. As shown in FIG. 12, the master node 1202 can generate a signal 114 having eight data streams DT00, DT10, DT20, DT30, DT01, DT11, DT21, DT31. The four data streams, DT00, DT10, DT20 and DT30 are transmitted by the first antenna in four time slots, T1, T2, T3 and T4. The other four data streams, DT01, DT11, DT21 and DT31 are transmitted by a second antenna in the same four time slots, T1, T2, T3 and T4. The relay node R0 1208 captures data streams in two time slots, T1, and T2. The relay node R0 1208 can use its first antenna to relay data stream from T1 in time slot T5 and use its second antenna to relay data stream from T2 in time slot T5. Similarly, the relay node R1 1210 captures data streams in two relay time slots, T3, T4. The relay node R1 1210 uses its first antenna to relay data stream from T3 in time slot T5 and use its second antenna to relay data stream from T4 in time slot T5. In this example, the maximum degree-of-freedom gain is 2×2×2=8 while the total number of antennas is 2+2×2=6.

### Rx DTR-MIMO:

FIG. 13 is a graphical representation of an embodiment of Rx DTR-MIMO communications in devices having multiple antennas. A receive group 1300 has one master node 1302 and two relay nodes 1304, 1306. Each node has two antennas. The relay node R0 1304 captures the data stream in time slot T0 and uses its two antennas to relay the signal in two time slots, T1 and T2. Similarly, the relay node R1 1306 captures the data stream in time slot T0 and uses its two antennas to relay the signal in two time slots, T3 and T4. The master node would receive four copies of the signal from its first antenna in four relay time slots and four copies of the signal from its second antenna in four relay time slots. Thus, the master node receives eight copies of the signal in total. The maximum degree-of-freedom gain is 2×2×2=8 while the total number of antennas is 2+2×2=6.

DR-MIMO can be applied to a master node with arbitrary number of antennas and an arbitrary number of relay nodes with arbitrary number of antennas provided that there are enough relay bands for DFR-MIMO systems (and sufficient buffer memory for DTR-MIMO systems).

In general, DR-MIMO can permit the use of MIMO with the distributed antennas (e.g., the relay nodes R1, R2, R3, R4) in the same way as a MIMO device having collocated antennas. Point-to-point MIMO using collocated antennas can be implemented for use with group-to-group communications. DR-MIMO enables the distributed nodes (e.g., the transmit group 100 and the receive group 200) to use the benefits of MIMO such as transmission of multiple spatial streams (DT0, DT1, DT2, DT3) to increase data rate through additional degree-of-freedom. Using the disclosed DR-MIMO techniques, it is possible to achieve n³ gain for power gain or range improvement, for n nodes in both the transmit group 20 and the receive group 30.

In some examples, DR-MIMO transmission (e.g., FIG. 2) and reception (e.g., FIG. 3) may not be coupled. The disclosed DR-MIMO scheme is not limited to the group-to-group communications. DR-MIMO transmission and reception can be two independent functions. For cellular or WiFi protocols (e.g., IEEE 802.11 family), a base station or access point (AP) can have many antennas but the user equipment (UE) may have only two antennas. DR-MIMO reception can be applied to enhance the UE MIMO capability and data throughput.

In some examples, joint transmission can require transmitted information to be known to all nodes. Without a backhaul connection, nodes (e.g., the transmitter 22 and the receiver 32) may need to use a decode-and-forward method through a local communications link to share information. However, using TDMA for the local communications link can require participating nodes to buffer received information (e.g., the spatial streams DT1, DT2, DT3, DT4) for a longtime. In some examples, the buffer time can be proportional to the number of cooperating or participating nodes. Hence, FDMA may be advantageous even with increased bandwidth requirements. A transmission time synchronization scheme may be needed for either using TDMA or FDMA to share information by the decode-and-forward method. Also note that decoding the signal can consume significant of power not to mention the handling of possible retransmissions due to error. Thus, DFR-MIMO can minimize the overhead required to achieve information sharing within the transmit group. No decoding is needed, minimizing power consumption. No complicated timing control is needed. More particularly, the DFR-MIMO methods disclosed herein bypasses the step of information sharing. The relay nodes R1, R2, R3, R4 need only repeat signals or portions of the signals (e.g., of the signal 110) without requiring digital processing, upper layer operations, or any knowledge of the contents of the signals (e.g., the signal 110 or the spatial streams DT0, DT1, DT2, DT3).

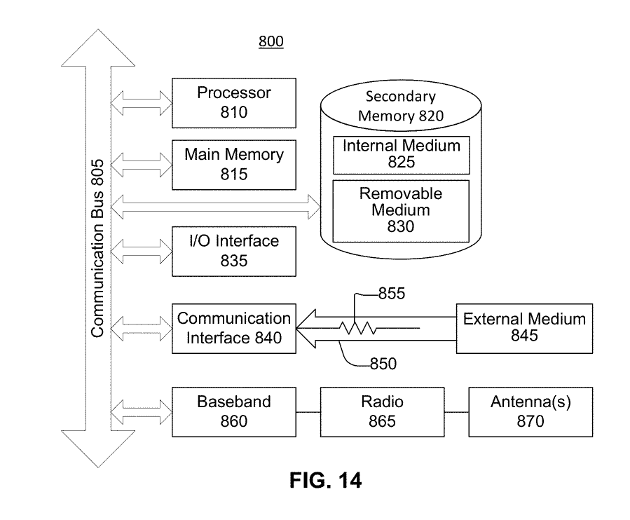

FIG. 14 is a functional block diagram of a wireless device of the transmit group and the receive group of FIG. 1. An exemplary wireless device 800 may be used in connection with various embodiments described in connection with FIG. 1 through FIG. 13. For example device 800 may be used as or in conjunction with one or more of the nodes (e.g., the master nodes and relay nodes), mechanisms, processes, methods, or functions (e.g., to store instructions and/or execute the application or one or more software modules of the application) described herein with respect to DR-MIMO, and may represent components of transmitter 22, the receiver 32, and the master nodes 102, 202, 302, 402, 502, 602, 702, and/or other devices described herein. The device 800 can also be implemented as one or more of the many relay nodes R1, R2, R3, R4 described herein for use in DR-MIMO. The device 800 can be a processor-enabled device that is capable of wired or wireless data communication using DR-MIMO. Other computer systems and/or architectures may be also used, as will be clear to those skilled in the art.

The device 800 can have one or more processors, such as processor 810. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 810.

Processor 810 can be coupled to a communication bus 805. Communication bus 805 may include a data channel for facilitating information transfer between storage and other peripheral components of device 800. Furthermore, communication bus 805 may provide a set of signals used for communication with processor 810, including a data bus, address bus, and control bus (not shown). Communication bus 805 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

Device 800 can have a main memory 815 and may also include a secondary memory 820. Main memory 815 provides storage of instructions and data for programs executing on processor 810, such as one or more of the functions and/or modules discussed above. It should be understood that programs stored in the memory and executed by processor 810 may be written and/or compiled according to any suitable language, including without limitation C/C++, Java, JavaScript, Perl, Visual Basic, .NET, and the like. Main memory 815 can be a semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 820 may optionally include an internal memory 825 and/or a removable medium 830. Removable medium 830 is read from and/or written to in any well-known manner. Removable storage medium 830 may be, for example, a magnetic tape drive, a compact disc (CD) drive, a digital versatile disc (DVD) drive, other optical drive, a flash memory drive, etc.

Removable storage medium 830 is a non-transitory computer-readable medium having stored thereon computer-executable code (e.g., disclosed software modules) and/or data. The computer software or data stored on removable storage medium 830 is read into device 800 for execution by processor 810.

In alternative embodiments, secondary memory 820 can include other similar means for allowing computer programs or other data or instructions to be loaded into device 800. Such means may include, for example, an external storage medium 845 and a communication interface 840, which allows software and data to be transferred from external storage medium 845 to device 800. Examples of external storage medium 845 may include an external hard disk drive, an external optical drive, an external magneto-optical drive, etc. Other examples of secondary memory 820 may include semiconductor-based memory such as programmable read-only memory (PROM), erasable programmable read-only memory (EPROM), electrically erasable read-only memory (EEPROM), or flash memory (block-oriented memory similar to EEPROM).

As mentioned above, the device 800 may include a communication interface 840. Communication interface 840 allows software and data to be transferred between the device 800 and external devices such as the relay nodes (e.g. another device 800), networks, or other information sources. For example, data, computer software, or executable code may be transferred to Device 800 from a network server via communication interface 840. Examples of communication interface 840 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing the device 800 with a network or another computing device. The communication interface 840 preferably implements industry-promulgated protocol standards, such as IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 840 are generally in the form of electrical communication signals 855. These signals 855 may be provided to communication interface 840 via a communication channel 850. In an embodiment, communication channel 850 may be a wireless network, or any variety of other communication links. Communication channel 850 can carry the signals 855 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs, such as for the disclosed DR-MIMO communications, or software modules) is stored in main memory 815 and/or the secondary memory 820. Computer programs can also be received via communication interface 840 and stored in main memory 815 and/or secondary memory 820. Such computer programs, when executed, enable device 800 to perform the various functions of the disclosed embodiments as described elsewhere herein.

In this description, the term “computer-readable medium” is used to refer to any non-transitory computer-readable storage media used to provide computer-executable code (e.g., software and computer programs) to device 800. Examples of such media include main memory 815, secondary memory 820 (including internal memory 825, removable medium 830, and external storage medium 845), and any peripheral device communicatively coupled with communication interface 840 (including a network information server or other network device). These non-transitory computer-readable mediums are means for providing executable code, programming instructions, and software to device 800.

In an embodiment that is implemented using software, the software may be stored on a computer-readable medium and loaded into device 800 by way of removable medium 830, I/O interface 835, or communication interface 840. In such an embodiment, the software is loaded into device 800 in the form of electrical communication signals 855. The software, when executed by processor 810, preferably causes processor 810 to perform the features and functions described elsewhere herein.

In an embodiment, I/O interface 835 provides an interface between one or more components of device 800 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and the like.

Device 800 may also include optional wireless communication components that facilitate wireless communication over a voice network and/or a data network. The wireless communication components comprise an antenna system 870, a radio system 865, and a baseband system 860. In the device 800, radio frequency (RF) signals are transmitted and received over the air by antenna system 870 under the management of radio system 865.

In an embodiment, antenna system 870 can have one or more antennae and one or more multiplexors (not shown) that perform a switching function to provide antenna system 870 with one or more transmit and receive signal paths. For example the several embodiments of the master nodes 102, 202, 302, 402, 502, 602, 702 described herein can each have one or more antennae allowing MIMO and/or DR-MIMO communications. The relay nodes described in connection with FIG. 2 through FIG. 13 can also have one or more antennae in their respective antenna systems 870.

In the receive path, received RF signals can be coupled from a multiplexor to a low noise amplifier (not shown) that amplifies the received RF signal and sends the amplified signal to radio system 865.

In an alternative embodiment, radio system 865 may comprise one or more radios that are configured to communicate over various frequencies. In an embodiment, radio system 865 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 865 to baseband system 860.

If the received signal contains audio information, then baseband system 860 decodes the signal and converts it to an analog signal. Then the signal is amplified and sent to a speaker. Baseband system 860 also receives analog audio signals from a microphone. These analog audio signals are converted to digital signals and encoded by baseband system 860. Baseband system 860 also codes the digital signals for transmission and generates a baseband transmit audio signal that is routed to the modulator portion of radio system 865. The modulator mixes the baseband transmit audio signal with an RF carrier signal generating an RF transmit signal that is routed to antenna system 870 and may pass through a power amplifier (not shown). The power amplifier amplifies the RF transmit signal and routes it to antenna system 870, where the signal is switched to the antenna port for transmission.

Baseband system 860 is also communicatively coupled with processor 810, which may be a central processing unit (CPU). Processor 810 has access to data storage areas 815 and 820. Processor 810 is preferably configured to execute instructions (i.e., computer programs, such as the disclosed application, or software modules) that can be stored in main memory 815 or secondary memory 820. Computer programs can also be received from baseband processor 860 and stored in main memory 815 or in secondary memory 820, or executed upon receipt. Such computer programs, when executed, enable Device 800 to perform the various functions of the disclosed embodiments. For example, data storage areas 815 or 820 may include various software modules.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, and algorithm operations described in connection with the embodiments disclosed herein may be implemented as electronic hardware, computer software, or combinations of both. To clearly illustrate this interchangeability of hardware and software, various illustrative components, blocks, modules, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

The hardware used to implement the various illustrative logics, logical blocks, and modules described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for distributed relay multiple-in multiple-out (DR-MIMO) communications in a wireless communication system having a transmit group and a receive group, the method comprising:
transmitting a message having a first spatial stream and a second spatial stream from a master transmit node of the transmit group toward the receive group, the first spatial stream spanning a first band and the second spatial stream spanning a second band;
capturing the second spatial stream at a first relay node of the of the transmit group;
relaying the second spatial stream by the first relay node of the transmit group in the first band as a relayed second spatial stream toward the receive group;
receiving a first data stream comprising the first spatial stream and the second spatial stream and a relayed second data stream comprising the first spatial stream and the second spatial stream at the master receive node; and
reconstructing the message at a master receive node based on the first data stream and the relayed second data stream.

2. The method of claim 1, wherein the reconstructing comprises performing joint MIMO detection at the master receive node.

3. The method of claim 1, wherein first band and the second band comprise a frequency band in frequency division multiple access (FDMA).

4. The method of claim 1, wherein the first band and the second band comprise a period of time in time division multiple access (TDMA).

5. The method of claim 1, wherein the master transmit node, the first relay node, and the master receive node comprise mobile wireless electronic devices.

6. The method of claim 1 further comprising:
receiving a second data stream comprising the first spatial stream and the relayed second spatial stream at a first relay node of the receive group in the first band; and
transmitting the second data stream in the second band as the relayed second data stream toward the master receive node of the receive group.

7. The method of claim 6, wherein one or more of the master transmit node, the first relay node, and the master receive node have a plurality of antennas.

8. The method of claim 6, wherein one or more of the master transmit node, the first relay node, and the master receive node have one antenna.

9. A system for distributed relay multiple-in multiple-out (DR-MIMO) communications in a wireless communication system, the system comprising:
a transmit group having,
a master transmit node configured to transmit a message having a first spatial stream and a second spatial stream, the first spatial stream spanning a first band and the second spatial stream spanning a second band, and
a first relay node configured to
capture the second spatial stream in the second band, and
relay the second spatial stream in the first band as a relayed second spatial stream; and
a receive group having a master receiver node configured to
receive a first data stream comprising the first spatial stream and the second spatial stream and a relayed second data stream comprising the first spatial stream and the second spatial stream, and
reconstruct the message based on the first data stream and the relayed second data stream.

10. The system of claim 9, wherein the receive group further comprises a second relay node configured to
receive the second data stream comprising the relayed second spatial stream and the first spatial stream in the first band; and
relay the second data stream in the second band toward the master receive node.

11. The system of claim 10, wherein one or more of the master transmit node, the first relay node, the second relay node, and the master receive node have one antenna.

12. The system of claim 9, wherein the reconstructing comprises performing joint MIMO detection at the master receive node.

13. The system of claim 9, wherein first band and the second band comprise a frequency band in frequency division multiple access (FDMA).

14. The system of claim 9, wherein the first band and the second band comprise a period of time in time division multiple access (TDMA).

15. The system of claim 9, wherein the master transmit node, the relay node, and the master receive node comprise mobile wireless electronic devices.

16. A non-transitory computer-readable medium in a distributed relay multiple-in multiple-out (DR-MIMO) wireless communication system having a transmit group and a receive group, the medium comprising instructions that when executed by a processor cause the system to:
transmit a message having a first spatial stream and a second spatial stream from a master transmit node of the transmit group toward the receive group, the first spatial stream spanning a first band and the second spatial stream spanning a second band;
capture the second spatial stream at a first relay node of the of the transmit group;
relay the second spatial stream by the first relay node of the transmit group in the first band as a relayed second spatial stream toward the receive group;
receive a second data stream comprising the first spatial stream and the relayed second spatial stream at a second relay node of the receive group in the first band;
transmit the second data stream in the second band as a relayed second data stream toward a master receive node of the receive group;
receive a first data stream comprising the first spatial stream and the second spatial stream and the relayed second data stream comprising the first spatial stream and the second spatial stream at the master receive node; and
reconstruct the message at the master receive node based on the first data stream and the relayed second data stream.

17. The non-transitory computer readable medium of claim 16, wherein first band and the second band comprise a frequency band in frequency division multiple access (FDMA).

18. The non-transitory computer readable medium of claim 16, wherein the first band and the second band comprise a period of time in time division multiple access (TDMA).

19. The non-transitory computer readable medium of claim 16, wherein one or more of the master transmit node, the first relay node, the second relay node, and the master receive node have one or more antennas.

20. The non-transitory computer readable medium of claim 16, wherein the transmit group and the receive group both comprise a plurality of relay nodes.
